(19) United States
(12) Patent Application Publication
(10) Pub. No.: US 2004/0026024 A1
(43) Pub. Date: Feb. 12, 2004

(54) Label affixing method and apparatus

(76) Inventors: Ikuo Nakasaka, Tokyo (JP); Takao Nozaki, Kyoto (JP); Kiyoharu Yoshimura, Kyoto (JP)

Correspondence Address: BIRCH STEWART KOLASCH & BIRCH, PO BOX 747, FALLS CHURCH, VA, 22040-0747, US

(21) Appl. No.: 10/442,943

(22) Filed: May 22, 2003

(30) Foreign Application Priority Data
May 22, 2002 (JP) P2002-147897
Sep. 30, 2002 (JP) 2002-288151

(51) Int. Cl. B32B 31/00

(52) U.S. Cl. 156/250; 428/343; 156/256; 156/272.2

(57) ABSTRACT

To provide a label construction and a method for its use to make the label hard to peel after affixed, when using the label having no releasable paper, which requires activation treatment of an adhesive agent layer. Further, to provide a label affixing method and an apparatus for the method to reduce the number of expensive printers when a label affixing operation is conducted at one time at a plurality of affixing site.

A reverse surface of a tape-shape label base material (2) is coated with an adhesive agent which does not adhesive at room temperature and a label expression (4) is continuously printed on a surface of the label base material (2). Whereby a label tape is formed and then the tape is shaped in a roll. The label tape is cut for each label (8) and is heated. After a plasticizing material is coated on the adhesive agent (3) which recovers adherence by heating, the label (8) is affixed. Even though there is some turn-up on the edge of the label after being affixed, it is possible to control the recrystallization of the adhesive agent to maintain the asdhesion and to prevent the label from peeling.

### BACKGROUND OF THE INVENTION

1. Field of the Invention

The present invention relates to a label with no releasable paper to be affixed to an adherend, a method for its use, and a method and apparatus for efficiently affixing the label.

In the present application, a label tape includes not only a tape-like label base material having one surface printed with a predetermined information required as the label and having the other surface provided with and without an adhesive agent layer but also the tape-like label base material on which the predetermined information required as the label have not yet been printed. Further, printing in the present application includes not only printing by various known large scale printing apparatus but printing by small scale printer such as ink-jet type and laser type printer which are controlled by personal computer.

2. Description of the Prior Art

A label to be affixed to a product and the like is generally coated with an adhesive agent on the reverse surface thereof in advance to expedite label affixing.

However, since the label has the reverse surface coated with the adhesive agent, a label tape formed by continuously extending a plurality of labels can not be stored by rolling it up. Accordingly, a method whereby the plurality of labels is affixed to a long belt-shaped release tape is usually carried out (refer to Japanese Unexamined Patent Publication No. HEI 9-216615 and the like).

However, since the release paper has to be disposed of as garbage after use, there is a problem in that it goes against resource saving and increases costs.

Examples in which the release tape is not used but the label tape having an adhesive layer on the reverse surface thereof is provided with a release agent layer on the front surface are proposed (refer to Japanese Unexamined Patent Publication No. HEI 9-258663, Japanese Unexamined Patent Publication No. 2001-183979 and the like). There is also a case where a heat-sensitive adhesive agent layer which is inactive at room temperature is formed and activated by heating when being affixed (Japanese Unexamined Patent Publication No. 2000-318718).

However, in examples in which the release tape is not used and is provided with a release agent, since the release agent layer has to be newly formed, it drives up costs. There is also a problem that workability is not good because the printing method is limited or printing cannot be performed at label tape affixing sites.

In examples in which the heat-sensitive adhesive agent layer being inactive at room temperature is formed, since release paper is not used, the cost for the release paper and the processing costs are not required. It is therefore possible to propose a label tape which can reduce the cost and which is excellent in workability.

Some special adhesive agents coated on the reverse surface of a label have properties that they are recrystallized when dried to lose the adhesive force. Accordingly, if there is any turn-up on the edge of the label even after being affixed to an adherend, the adhesive agent starts drying from that point and the label gradually comes off.

In the above-mentioned types with the releasable paper or the release agent layer, for example, if a label with no releasable paper on which necessary information is printed is cut for each label, handling is troublesome because an adhesive agent layer is exposed. Since the individually cut label cannot be carried around, the label is substantially printed and cut from a roll condition at an affixing site and is forced to be used immediately. Accordingly, in the case where there are may independent label affixing sites, since it is required to install an expensive label-affixing device for each affixing site, a method and apparatus for affixing the label at a low price is desired. Even if there is only one label-affixing site, it is inconvenient if the affixing site is far from a printing site. This also applies to the case of patent document 4. Namely, even though handling is made easy by forming an inactive adhesive agent layer and there is plenty of time from cutting of the label until affixing, cost reduction in the equipment cannot be expected.

The present invention has been achieved in view of these points and it is therefore an object of the present invention to provide a label, a method for its use, and a method and apparatus for affixing the label which can prevent peeling due to drying of an adhesive agent while keeping the cost down and maintaining excellent workability.

### SUMMARY OF THE INVENTION

To attain the above-mentioned object, a label according to claim 1 is provided, in which the predetermined information required as the label has a front surface printed with label pictures and a reverse surface coated with an adhesive agent which does not adhere at room temperature, but recovers the adherence when heated, characterized in that a plasticizing material is coated on the adhesive agent which recovers adherence by heating.

In the invention of claim 2, the label according to claim 1 is characterized in that the label is formed in a long belt-shape on which a plurality of the predetermined information required as the label are continuously printed.

The invention according to claim 3 relates to a method for using a label, in which the label having a reverse surface coated with an adhesive agent which does not adhere at room temperature, but recovers adherence when heated is first heated to generate an adhesive force and then a plasticizing material is coated on the adhesive agent, thereby affixing the label to the adherend.

The invention according to claim 4 relates to a method for using a label in which a label formed in a long belt-shape is continuously printed with a plurality of the required information on a surface and has a reverse surface coated with an adhesive agent which does not adhere at room temperature, but recovers adherence when heated, the method for using the label comprising the steps of forming a tape roll by rolling a long belt-shape label tape in a roll, unrolling the label tape from the tape roll, cutting the printed label tape for each label, heating the adhesive agent on the reverse surface of the cut label using a heater, coating a plasticizing material on the adhesive agent which recovers adherence by heating, and affixing the label to an adherend by the adhesive agent coated with the plasticizing material.

The invention according to claim 5 relates to a method for using a label, in which a label tape formed in a long belt-shape has a reverse surface coated with an adhesive agent which does not adhere at room temperature, but recovers adherence when heated, the method comprising the steps of forming the tape roll by rolling a long belt-shape label tape in a roll, unrolling the label from the tape roll, continuously printing the required information on the surface of the unrolled label, cutting the printed label tape for each label, heating the adhesive agent coated on the reverse surface of the cut label using a heater, coating a plasticizing material on the adhesive agent which recovers adherence, and affixing the label to an adherend by the adhesive agent coated with the plasticizing material.

A method for affixing a label having no releasable paper according to claim 6 comprises the steps of continuously printing a plurality of labels on a long label tape and cutting the label tape into predetermined lengths using one printer, thereby feeding the label tape to one or more label affixing sites, and separating the label tape for each label in the label affixing site and activating an adhesive agent layer by a separating means, thereby performing an affixing operation.

In claim 7, a label tape in a printing process is not provided with an adhesive agent layer. The adhesive agent layer is formed by a separating means.

An apparatus according to claim 8 of the present invention comprises a printer for continuously printing a plurality of labels on a long label tape, and a separating means for separating the printed label tape for each label and activating an adhesive agent layer, wherein one or more separating means are provided for one printer, the label tape printed out by the printer in predetermined lengths is brought to the separating means, and wherein the separating means separates and activates the label individually to perform the affixing operation.

In this case, the separating means can be provided with a label feeding section, a cutting section, a conveyor section, an activating section, and an ejection section. An plasticizer coating section can also be provided for coating a plasticizer on the activated adhesive agent layer by way of blowing, roll transfer or brushing. When the plasticizer coating section is provided with a transfer roller for roll transferring the plasticizer and a pressure roller for applying pressure on the surface of the transfer roller, the pressure roller can be moved vertically by a solenoid or a motor. Further, the ejection section of the separating means can be provided with an ejection mechanism by a belt of which the cross-section is round.

An apparatus according to claim 9 has a similar construction to claim 8 and comprises a printer for continuously printing a plurality of labels on a long label tape, which is not provided with an adhesive agent layer and separating the label tape into predetermined lengths, and a separating means for separating the printed label tape for each label to form the adhesive agent layer. The separating means can be provided with a label feeding section, a cutting section, a conveyor section, an adhesive agent forming section, and an ejection section. The adhesive agent forming section can also be provided with an adhesive agent container or cartridge for forming the adhesive agent layer on the label conveyed from the conveyor section by blowing, roll transferring or brushing and for preventing the adhesive agent from drying.

In each device of claim 8 and claim 9, the feeding section of the separating means can be provided with a supporting member for supporting the printed label tape of a roll shape and a mechanism for feeding the labels one by one. The supporting member can be swingably provided. The feeding section can also be provided with a mechanism for feeding a folded label tape and a structure for feeding the label one by one. Further, it is possible to provide a detecting means for detecting part of the label and feeding the label to the cutting section at a fixed pitch relative to the label tape or the labels fed individually. It is also possible to provide the cutting section with a cutter for cutting the label, individually or continuously, fed from the feeding section.

Still further, the conveyor section can be constructed in such a manner that the label is conveyed by way of a belt or roller, absorption, holding or adhesion.

According to the invention of claim 1, since the adhesive agent coated on the reverse surface of the label does not adhere at room temperature, it can be easily handled without use of a release paper. It is therefore possible to keep the cost down and to attain the resource saving because the cost of release paper and the handling cost therefor are not required. Further, the plasticizing material is coated on the adhesive agent which recovers adherence by heating. Accordingly, even though there is some turn-up on the edge of the label after being affixed, it is possible to control the recrystallization of the adhesive agent to maintain the adhesion and to prevent the label from peeling.

According to the invention of claim 2, the adhesive agent coated on the reverse surface of the label does not adhere at room temperature. Accordingly, the label can be formed in a long belt-shape, wherein the plurality of the predetermined information required as the label can be continuously printed thereon. Since the label can be formed in a roll-shape, the label can be kept as a roll and the handling is also convenient.

By providing slits, perforated line or the like on the border between adjacent label, it is possible to simply and accurately separate each label to be affixed to an adherend.

According to the invention of claim 3, the label can be affixed to the adherend by a simple method whereby the plasticizing material is coated on the adhesive agent which generates the adhesive force by heating to be affixed to the adherend. Even though there is some turn-up on the edge of the label after being affixed, it is possible to control the recrystallization of the adhesive agent to maintain the adhesion and to prevent the label from peeling.

Since a release paper is not required and treatment after affixing the label is not troublesome, it is possible to keep the cost down and to attain resource savings.

According to the invention of claim 4, in this manner, it is possible to unroll in use the long belt-shaped label tape, which was printed with the predetermined information required as the label in advance and was kept as a roll. The label tape is cut for each label and is heated using the heater to cause the adherence of the adhesive agent on the reverse surface to easily recover. After the plasticizing material is coated on the adhesive agent which recovers adherence, the label is affixed to the adherend. Accordingly, it is possible to easily handle the label and improve the working efficiency.

Even though there is some turn-up on the edge of the label after being affixed, it is possible to control the recrystallization of the adhesive agent to maintain the adhesion and to prevent the label from peeling.

According to the invention of claim 5, the long label tape is unrolled from the tape roll before printing at label affixing sites, is printed with the predetermined information required as the label, and is cut for each label, wherein the adhesive agent is heated using the heater, is coated with the plasticizing material, and the label is then affixed to the adherend. In this manner, since the required information can be freely printed at the site, it is convenient. Further, the label tape formed in the long belt-shape to be used as the tape roll can be widely used and it is possible to reduce the cost.

According to an affixing method of claim 6, a label tape is formed by continuously printing the required number of labels on a label with no releasable paper and separating the label into predetermined lengths using a printer. In this case, an adhesive layer remains an inactive adhesive agent layer and releasable paper is not necessary. Then, the label tape is brought to a working site where it is dispersedly provided around the printer, and is set in the separating means.

The separating means separates the continuous label sheet for each label and activates the inactive adhesive agent layer, thereby affixing each label to a package or the like. This can be performed together at a plurality of working sites.

In this manner, it is possible to do with only one expensive computer, raise the efficiency of use of the printer, and reduce the entire cost. Since the releasable paper need not be generated, it is possible to lessen the burden on the environment. In addition, since the separating means is provided near the affixing site, it is possible to make the affixing operation easy. Even in the case where there is but one affixing site and it is a considerable distance from the printing site, the printer and the separating means can be separately provided. Accordingly, unnecessary equipment is not needed and the affixing operation can be carried out at the affixing site.

According to a method of claim 7, since an adhesive agent layer is formed by the separating means, it is possible to do without the label with no releasable paper in which a special adhesive agent is used, and the activating means is not necessary. In this manner, it is possible to easily realize affixing of the label without the releasable paper.

According to an apparatus of claim 8, the printer is separated from the separating means. Since the printer can print out label tapes, of which the adhesive agent layer is inactive, in given predetermined lengths and the separating means can separate and activate the labels, it is possible to make the operation at the affixing site easy. In addition, since one or more separating means can be provided for one printer, it is possible reduce the entire cost of the equipment. Even in the case where one printer and one separating means are provided, if there is but one affixing site and it is far from the printing site, it is not necessary to install the printer in the affixing site.

Further, if the separating means is provided with a feeding section, a cutting section, a conveyor section, an activating section, and an ejection section, it is possible to make the separating means fully function. When the separating means is additionally provided with a plasticizer coating section, it is possible to prevent a decrease in performance due to crystallization of the activated adhesive agent and to make long and stable use possible. In this case, when the plasticizer coating section is provided with a transfer roller for the plasticizer and a pressure roller, if the pressure roller is vertically moved by a solenoid or a motor, it is possible to prevent excessive adhesion of the plasticizer. Further, when the ejection section is provided with an ejection mechanism by a belt of which the cross-section is round, it is possible to reduce the quantity of the adhesive agent or the plasticizer which adheres to the belt of the ejection section, and workability also improves.

According to an apparatus of claim 9, since the separating means is provided with an adhesive agent layer forming section, it is possible to form an adhesive agent layer just before affixing by the separating means which is located at the affixing site and to improve the handling properties. It is also possible to easily form the adhesive agent layer by blowing, roll transfer or brushing. Further, if an adhesive agent container or cartridge is provided, it is possible to prevent the adhesive agent from drying.

In each apparatus of claim 8 and claim 9, the feeding section of the separating means can not only support the printed label tape of a roll shape by a supporting member, but also can feed the labels individually. In this case, if the supporting member is swingably provided, the direction of feeding can be selectively changed according to the material of the label tape and the like. The feeding section can also be arranged to feed a folded label tape. It is also possible to realize correct feeding by providing a detecting means for detecting part of the label and for feeding the label to the cutting section at a fixed pitch relative to the label tape or the labels fed individually. By the provision of this feeding mechanism, the labels can be cut individually or continuously by a cutter.

Further, it is possible to construct the conveyor section as a belt or roller, absorption, holding or adhesion.

### BRIEF DESCRIPTION OF THE DRAWINGS

FIG. 1 is a perspective view showing a label tape and a tape roll according to a first embodiment;

FIG. 2 is a cross-sectional view of the label tape taken along the line 2-2 of FIG. 1;

FIG. 3 is a cross-sectional view of a label;

FIG. 4 is an external view of a label supply device;

FIG. 5 is a schematic view giving an inner schematic structure of the label supply device;

FIG. 6 is a partially perspective view of the label supply device.

FIG. 7 is an entire schematic view according to a second embodiment;

FIG. 8 is a perspective view of a label;

FIG. 9 is a cross-sectional view of the label;

FIG. 10 is a schematic structural diagram of a printer;

FIG. 11 is a perspective view of a separating means;

FIG. 12 is a schematic structural view of the separating means;

FIG. 13 is a schematic view showing feeding of the label in the separating means;

FIG. 14 is a view showing a return roller; and

FIG. 15 is a view showing a discharge pinch roller and an ejection belt.

### DETAILED DESCRIPTION OF THE PREFERRED EMBODIMENTS

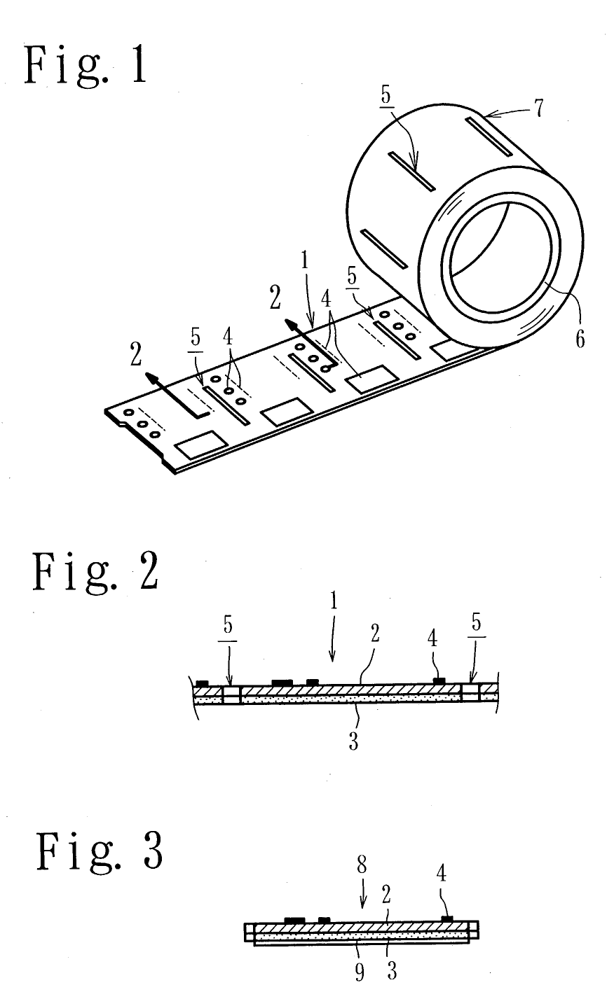

A first embodiment according to the present invention will now be explained with reference to FIGS. 1 through 3. As shown in FIGS. 1 and 2, a label tape 1 of a long belt-shape according to the present embodiment has a paper label base material 2 of a long belt-shape of which the front surface is continuously printed with a plurality of label expression 4 and of which the reverse surface is coated with a special adhesive agent 3 (refer to FIG. 2).

The adhesive agent 3 does not adhere at room temperature, but recovers adherence when heated. For example, an adhesive agent such as EN900 of Dainippon Ink & Chemicals, Inc. is considered.

The label expression 4 can be printed on the paper of the label base material 2 using various printing methods and these are continuously printed in sequence.

On the label tape 1, a plurality of the label expression 4 is provided with the predetermined information required as the label continuously printed, and long slits 5 (or perforated lines) are formed in the width direction on the center of the boundary between adjacent label expression 4, 4.

The adhesive agent 3 coated on the reverse surface of the label base material 2 does not adhere at room temperature. Accordingly, even though the label tape 1 is wound around a roll core 6 in a roll shape as shown in FIG. 1, it does not mutually adhere, does not have any disadvantage in unrolling and can be easily stored. Further, since the label tape 1 does not adhere to all sides, handling is easy and it is convenient.

In the present embodiment, the label tape 1 is provided so that the front surface on which the label expression 4 are printed is wound around the roll core 6 in a roll shape to form a tape roll 7 of the label tape 1.

The label tape 1 is unrolled from the tape roll 7 and the label 8 at the head is cut out along the slits 5. The adhesive agent 3 on the reverse surface of the label 8 is then heated to recover adherence, wherein a plasticizing material 9 is coated on the adhesive agent 3 to be affixed to an adherend (see FIG. 3).

The plasticizing material 9 is made of terpene resin. When the plasticizing material 9 is coated on the adhesive agent 3 which recovers adherence by heating, recrystallization of the adhesive agent can be controlled, even though being exposed to air, to maintain the adhesive force.

Accordingly, even though some turn-up is caused to the edge of label 8 after being affixed to the adherend, the plasticizing material 9 can maintain the adhesive force of the adhesive agent 3 to stop the development of peeling, thereby preventing the label 8 from peeling.

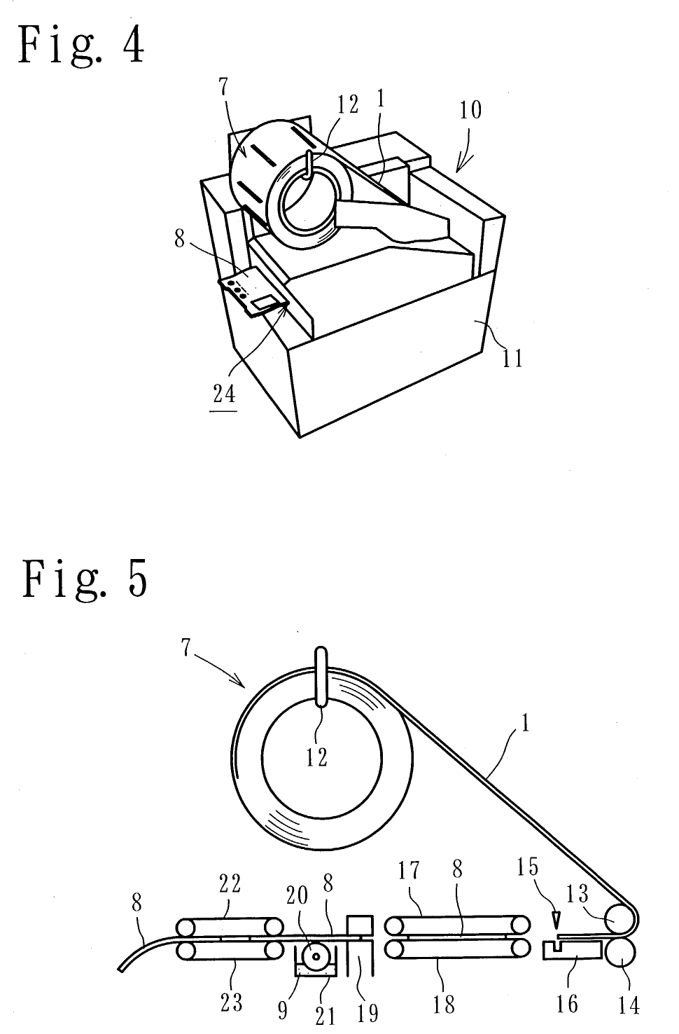

The above-mentioned operation can be carried out by hand, but can be executed by a label supply device 10 as shown in FIGS. 4 though 6.

The label supply device 10 is provided to mount each mechanism on a case 11 as shown in FIG. 4, wherein the tape roll 7 is rotatably supported by an arm 12, which is a bar-like supporting member, horizontally projecting above the base 11.

A schematic construction of the label supply device 11 is shown in FIG. 5.

A pair of upper and lower unwind rollers 13, 14 is provided at the lower right of the tape roll 7 supported by the arm 12. The label tape 1 unrolled at the lower right of the tape roll 7 is supported by the upper unwind roller 13 to be inserted between the upper unwind roller 13 and the lower unwind roller 14 and is pulled out horizontally.

Provided on the exit side of the unwind rollers 13, 14 is a cutting machine provided with a cutter blade 15 and a cutter receiver 16. The label tape 1 is pulled out to a predetermined position and then cut along the slits 5 between the label expression 4 and the next label expression 4 at the end sections of the label tape 1 by the cutter blade 15 to cut away the end label 8.

The cut away label 8 is inserted and conveyed between a pair of upper and lower conveyor belts 17, 18 provided on the downstream side of the cutting machine.

A heater 19 is provided on the downstream side of the conveyor belts 17, 18. The label 8 conveyed and pushed out by the conveyor belts 17, 18 is heated by the heater 19 to recover adherence of the adhesive agent 3 coated on the reverse surface of the label 8.

The label 8 can be heated from at least one of the front and reverse surfaces.

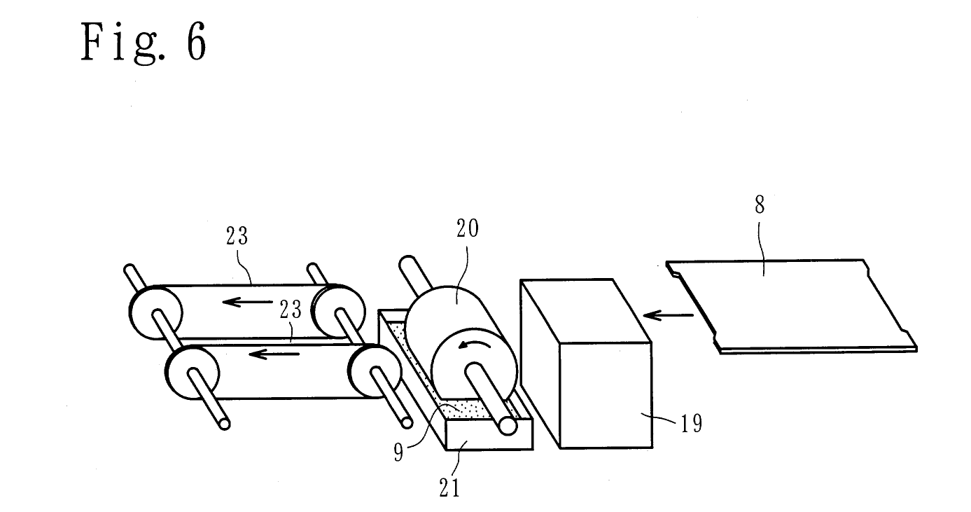

As shown in FIGS. 5 and 6, a sponge roller 20 is rotatably provided on the downstream side of the heater 19. The lower section of the sponge roller 20 is immersed in the plasticizing material 9 in a liquid condition stored in a tray 21 provided below the sponge roller 20.

In this manner, the sponge roller 20 absorbs the plasticizing material 9. The plasticizing material 9 is coated on the lower surface (i.e., the reverse surface) of the label 8 by the self-rotation of the sponge roller 20 during conveyance of the label 8.

The lower surface (the reverse surface) of the label 8 is in a condition where adherence is recovered by heating the adhesive agent 3 by the heater 19, wherein the plasticizing material 9 is coated on the lower surface of the label 8.

Provided on the downstream side of the sponge roller 20 is a pair of upper and lower ejecting belts 22, 23 which receive the label 8 from the sponge roller 20 and convey the label 8 toward an outlet 24 inserting it therebetween.

As shown in FIG. 6, the lower conveyor belt 23 of the pair of ejecting belts 22, 23 is provided in such a manner that a pair of front and rear endless ropes are supported by front and rear rollers. The lower conveyor belt 23 is designed to make the area where it contacts the adhesive agent 3 which recovers adherence on the lower surface (reverse surface) of the label 8 and the plasticizing material 9, as small as possible for conveyance.

The back end of the label 8 is inserted between the ejecting belts 22, 23 and is held in such a condition so that the label 8 projects outwards as shown in FIG. 4. By pulling the projecting label 8, the back end of the label 8 is easily removed from the ejecting belts 22, 23. In this manner, the label 8 can be taken out.

As described above, the label supply device 10 supplies the label 8 in a affixable condition in sequence by automatically conducting each process of unrolling the label tape 1 from the tape roll 7, cutting the label at the head, heating the adhesive agent 3 on the reverse surface, and coating the plasticizing material 9.

In this manner, a worker can take the label 8 projecting from the outlet 24 of the label supply device 10 and can affix the label 8, of which the adhesive agent 3 on the reverse surface has recovered adherence and which is in a condition where the plasticizing material 9 has been coated on the adhesive agent 3, directly to the adherend. Accordingly, the workability is excellent.

Even though there is some turn-up on the edge of the label 8 after being affixed to the adherend, the plasticizing material 9 can maintain the adhesive force of the adhesive agent 3 to stop the development of peeling, thereby preventing the label 9 from peeling.

The label supply device 10 is made of a simple structure, is small, and does not require a space. Accordingly, the label supply device 10 can be used anywhere and is convenient.

Since the present label tape 1 is not provided with release paper, the costs for the release paper and the treatment are not required. It is possible to keep the costs low and attain resource saving.

Since the adhesive tape 3 coated on the reverse surface of the label tape 1 does not adhere at room temperature, it can be stored as the tape roll 7 and handling is convenient.

Though the label supply device 10 uses the pre-printed label tape 1 as the tape roll 7, if the device 10 is provided with a printing function, it is possible to use the label tape before printing which can be freely printed, as the tape roll. In this manner, the label supply device can perform each process of unrolling, printing, cutting, heating, and coating of the plasticizing material, thereby discharging a label which can be affixed directly.

By storing the label tape before printing as the tape roll, it is possible to provide high versatility and reduce costs. Since label pictures can be printed later, it is possible to print the label pictures and affix the tape at various tape-affixing sites. The label tape is therefore convenient.

In the present label tape, the printing surface is not coated with release paper and the like. Accordingly, the label tape is simple in structure, costs can be kept low, the printing method is not limited, the label pictures can be freely printed any time, and handling is also convenient.

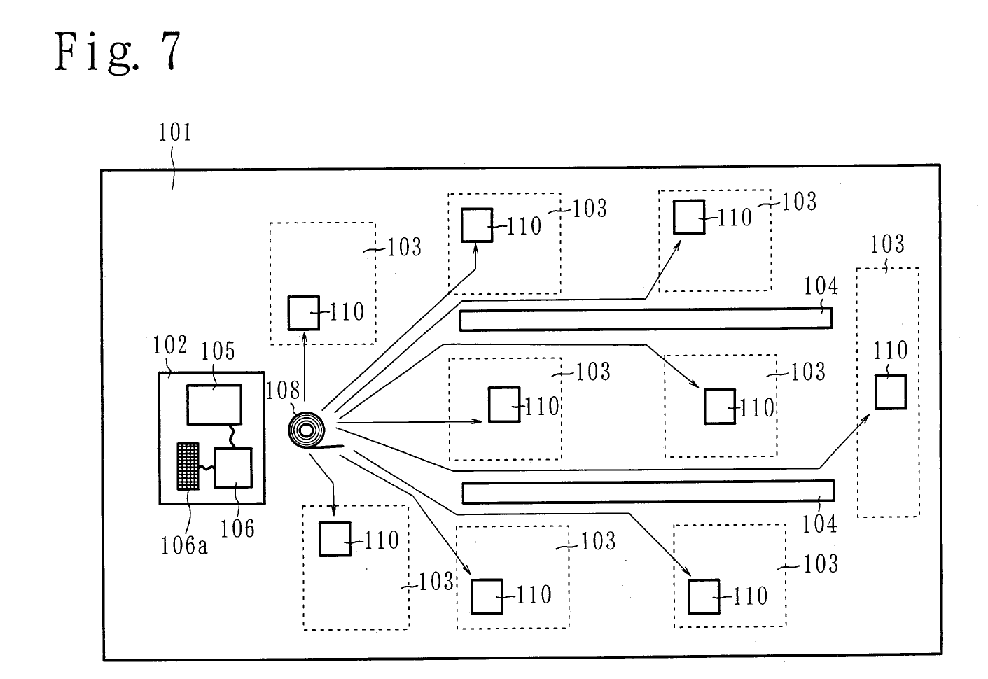

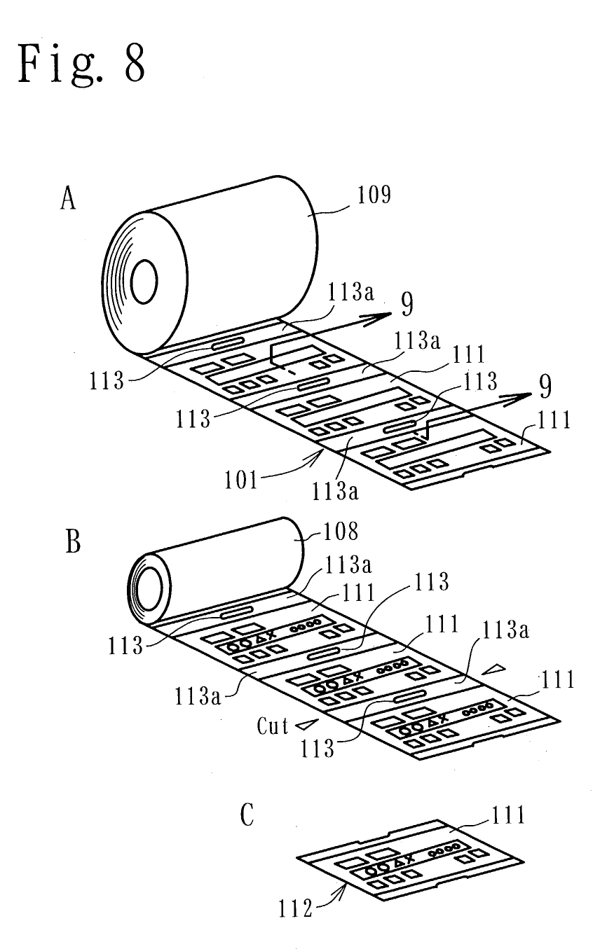

A second embodiment of the present invention will be described with reference to the accompanying drawings. FIG. 7 is an entire system chart and FIGS. 8 and 3 show a label without releasable paper used herein.

In FIG. 7, a label supply center 102, separate work areas 103, 103, . . . and a conveyor line 104 and the like are provided in a collective working area 101 such as a factory.

Connected to the label supply center 102 are a printer 105, a computer 106 which issues a printing command, and an external input means 106a such as a keyboard for inputting required characters and the like from outside. A notebook-sized personal computer, a desktop personal computer and the like are available as the computer 106, which can set the required format, cutting width, required information, required number of sheets of the label, and the like and cause the printer 105 to print.

In the label supply center 102, a printer 105 continuously prints predetermined information on an unprinted continuous tape 107 and then, cuts the printed continuous label tape 108 in a length for the required number of labels to be rolled in a roll-shape and supplied in a shape such as a tape roll. Although the unprinted continuous tape 107 and the printed continuous tape 108 are the label tape in the present application, they are especially used here as different ones. The printed continuous label tape 108 is printed with the contents corresponding to separate work area 103. The continuous label tape 108 is then taken to the separate work area 103 from the label supply center by a worker, installed in a separating means 110 provided in separate work area 103, separated for each label, and put in a activated condition. It is to be noted that the printer 105 is a completely separate member from the separating means 110.

The separate work area 103 is independent in the label affixing work, wherein the label having the same or different contents is affixed to an adherend such as a product and a package. As shown in the figure, some of the work areas 103 are connected by the conveyor line 104. The number of work areas 103 is one or more and these are dispersedly provided around the label supply center 102.

The degree of dispersion from the label supply center 102 requires that the distance is too far to efficiently carry each label one by one from the label supply center 102 to each work area 103. The further the distance, the worse the efficiency in the case where separate label is intensively issued in the label supply center 102.

FIG. 8A shows an unprinted continuous tape 107, FIG. 2B shows a printed continuous tape 108, and FIG. 8C shows a label 112 cut one by one. As shown in FIG. 8A, the unprinted continuous tape 107 is formed in the shape of a long tape before the label with no releasable paper is cut and is installed in the printer 105 as roll paper 109.

Printed on the surface (hereinafter referred to as a “printing surface”) of the unprinted continuous tape 107 in advance is a label indicating section 111 consisting of a common element such as a logo or frame of the label. A predetermined gap 113a is formed between the adjacent label indicating sections 111 and 111 and a sensor mark 113 is formed therein. In the present embodiment, a slit for a translucent sensor is provided. It should be noted that all the surface of the roll paper 109 can be left plain-colored so that the common element and an individual element are printed by the printer on a case-by-case basis.

The printed continuous tape 108 of FIG. 8B is formed by continuously printing a predetermined individual element on a blank column of the label indicating section 111 for the required number of labels by the printer 105 and cutting the roll paper 109 in a length for the required number of labels. The printed continuous tape is wound manually or by a winding machine to form a roll for easy handling.

The label 112 of FIG. 8C is cut on the gap 113a and is separated from the printed continuous tape 108.

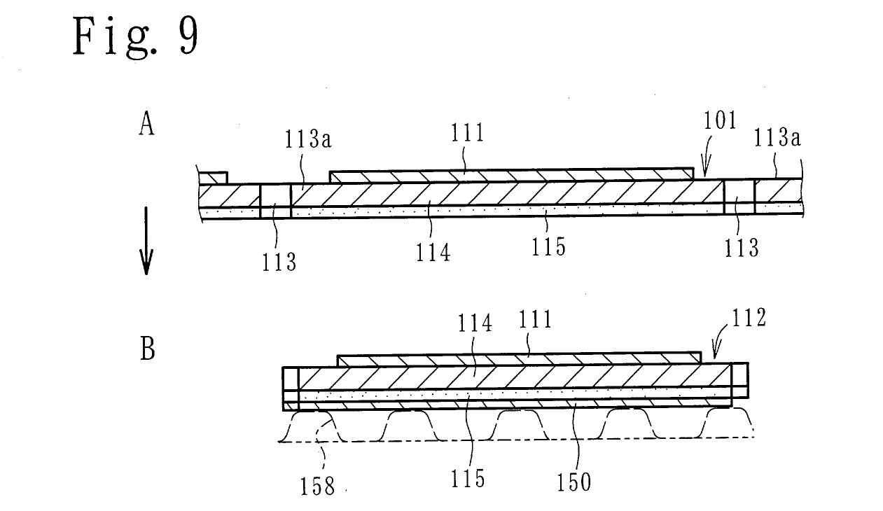

FIG. 9A is a cross-sectional view taken along the line 9-9 of FIG. 8A. As shown in the figure, the continuous label tape before printing 107 is formed with the label indicating section 111 on the surface of a label base material 114 made of a suitable material such as paper, resin (plastic) or metal. The unprinted continuous label tape 107 is provided with an adhesive agent layer 115 on the reverse surface thereof (hereinafter referred to as an “affixing surface”). This adhesive agent layer 115 is made of a known adhesive agent, keeps an inactive condition until being activated by a predetermined operation and maintains an active condition after being activated. In the present embodiment, a thermal active type of hot melt is used, which is an inactive paste layer at room temperature, is activated by heating at a predetermined temperature, and then, maintains the active condition. For example, an adhesive agent such as EN900 of Dainippon Ink & Chemicals, Inc. is considered suitable.

FIG. 9B is a cross-sectional view showing the condition of one label which is cut at the gaps 113a, 113a on each side of FIG. 9A. In this condition, a plasticizer 150 described later is coated on the surface of the adhesive agent layer 115. Reference numeral 158 is an adherend which shows an example of a known air cushion sheet forming air cushion.

When such a label without releasable paper is used, the printed continuous tape 108 required in a plurality of separate working areas 103, 103, is intensively processed in the label supply center 102. A worker of each working area 103 can carry the printed continuous tape 108 of which the adhesive agent layer 115 is in an inactive condition. Accordingly, even though only one printer 105 is provided, it is possible to efficiently activate the printer 105. It should be noted that the printer 105 can be combined in such a manner that one or more separating means 110 are provided for one printer. In a large work area, a plurality of combinations can be considered.

If the worker of separate work area 103 secures a volume of the printed continuous tapes 109 sufficient to meet the requirements of his area, he does not have to go to and from the label supply center 102 frequently. Thus, he can work without a break even though his working area is far from the label supply center 102. In this manner, the length of the printed continuous tape 108 can be set for separate work area 103 to reduce the number of carrying the printed continuous tapes 108 as much as possible. A sensor mark 113 is an important factor in making this dispersion system possible in practice and will be described below.

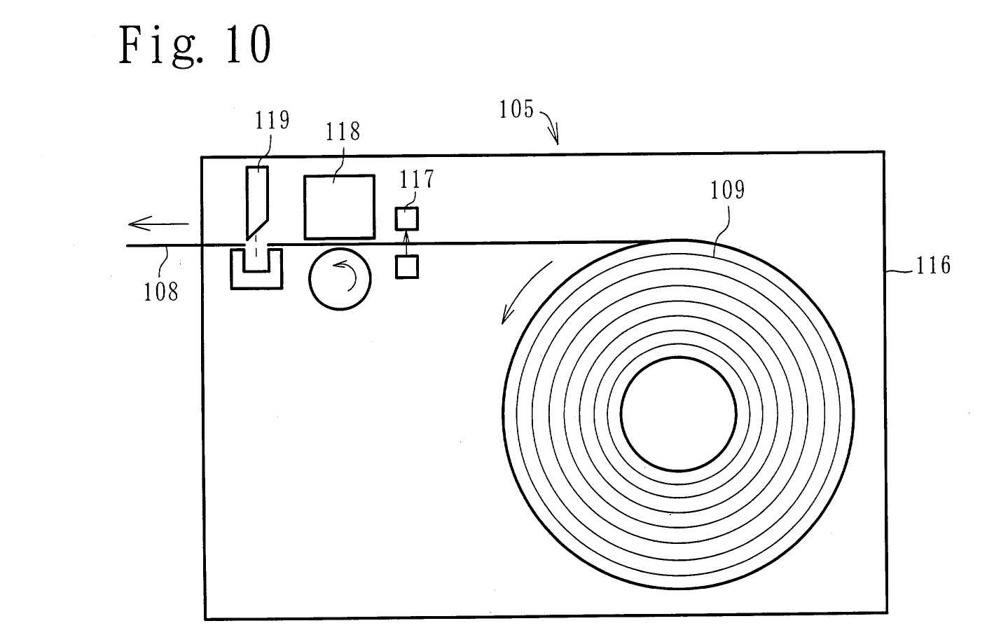

The printer 105 will now be explained. FIG. 10 schematically shows a structure of the printer 105. When a leading end of the unprinted continuous tape 107 fed from the roll paper 109 enters a casing 116 making the front surface of the tape 107 face upward, a position of the sensor mark 113 is detected by a transmitted light sensor 117. Namely, when the sensor mark 113 passes above the transmitted light type sensor 117, light is transmitted through a slit forming the sensor mark 113, wherein the transmitted light sensor 117 detects the position of the sensor mark 113.

After a predetermined time passes from the detecting point, a predetermined printing is performed on the label indicating section of the unprinted continuous tape 107 by a print head 118. By repeating this until sensor marks 113 for the required number of labels pass, printing for the required number of labels is performed. When the number of sensor marks 113 reaches the number specified for the required number of labels, a cutter 119 is actuated after the predetermined time to cut the tape from the roll paper, thereby forming the printed continuous tape 108.

This cut timing is precisely set by the length (i.e., cut width) in the line direction of the width between the gaps 113a and 113a and the conveyance speed. The cut printed continuous tape 108 is wound manually or by winding equipment provided in the printer 105, the separating means 110 and the like to form a roll.

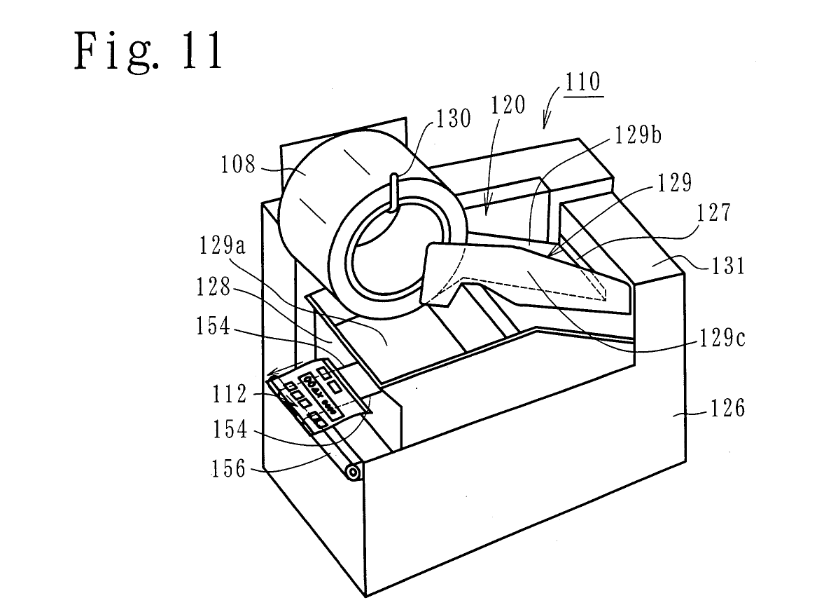

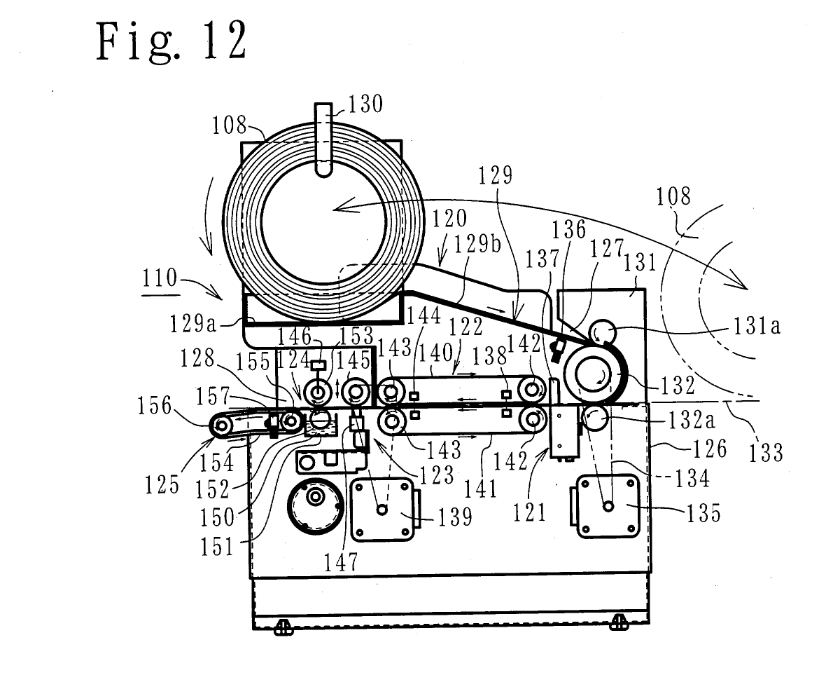

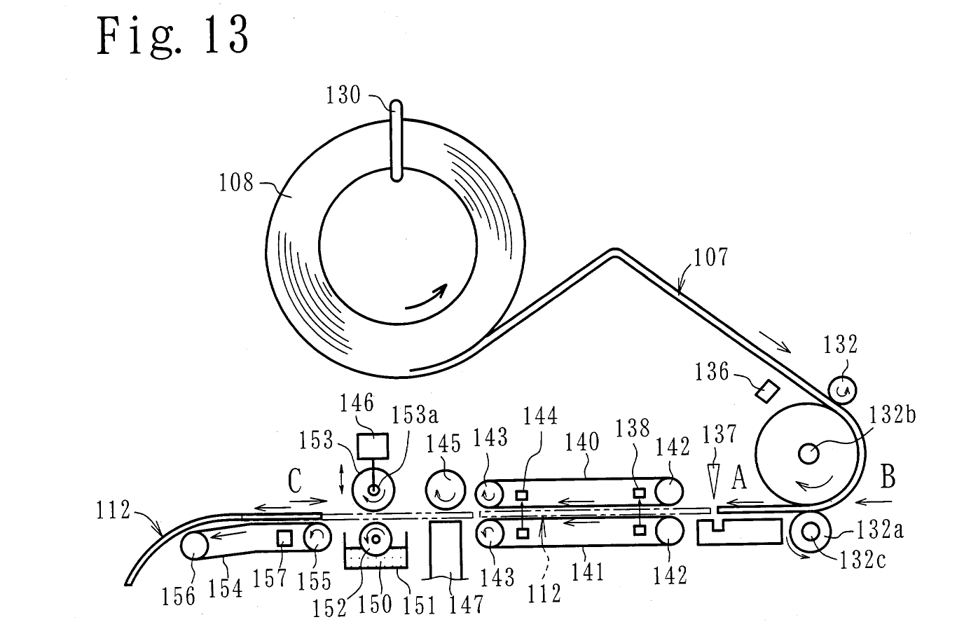

The separating means 110 will now be explained. FIG. 11 is a perspective view of the separating means 110 constructed as a separating and activating device and FIG. 12 is a schematic structural view thereof FIG. 13 is a view schematically showing feeding of the label. In these figures, the separating means 110 is almost same as the label supply device 10 in the first embodiment and provided with a feeding section 120, a cutting section 121, a conveyor section 122, an activating section 123, a plasticizer coating section 124, and an ejection section 125. Reference numeral 126 is a casing which is provided with an inlet 127 on one end of the longitudinal direction and a discharging outlet 128 on the other end. Detachably mounted on the upper section of the casing 126 is a paper feeding section cover 129.

The feeding section 120 is a section for feeding the printed continuous tape 108 formed in a roll condition and the like or the label separately cut in advance. Provided above the discharging outlet 128 is an L-shaped arm 130, which is a supporting member for supporting the printed continuous tape 108 formed in a roll shape. The end of the paper feeding section cover 129 below the L-shaped arm 130 is a depressed portion 29a for receiving the printed continuous tape 108.

An inclined plane 129b is formed between the depressed portion 129a of the paper feeding section cover 129 and the inlet 127 to guide one end of the printed continuous tape 108 of which the reverse surface is up. In the case where only one label is put on the inclined plane 129b, it automatically slides down to the inlet 127. Reference numeral 129c of FIG. 11 is a lateral guide plate for guiding each end of the continuous tape 108 in the lateral width direction. The lateral guide plate 129c can be moved and adjusted in the lateral width direction of the continuous tape 108 on the paper feeding section cover 129 according to the lateral width of the continuous tape 108.

The inlet 127 is surrounded with a return portion cover 131. A return roller 132 and idle rollers 131a and 132a are provided inside the return portion cover 131. The return roller 132 is driven to rotate by an inlet motor 135 via a belt 134 to insert the printed continuous tape 108 between the return roller 132 and the idle rollers 132a, thereby changing the direction of the printed continuous tape 108 at about 180 degrees. The printed continuous tape 108 is then fed in the direction of the arrow A of FIG. 13 along a substantially horizontal conveyance path 133 from the return roller 132 making the front surface face upward.

The inlet 127 is provided with an inlet sensor 136. The inlet sensor 136 is composed of a touch-type sensor or the like. The inlet sensor 136 detects when the printed continuous tape 108 and the like enter the inlet 127 and drives the inlet motor 135 to guide the label inside the device.

As shown in a virtual line, the arm 130 can be swingably provided. The arm 130 provided with the printed continuous tape 108 can be reclined to a substantially lateral position of the return roller 132. In this manner, since it is not necessary to return the printed continuous tape 108, this is advantageous when handling a thick roll. However, if the arm 130 is constructed as shown in a solid line, it is possible to make the feeding section 120 compact as a whole. The arm 130 can also be provided in a lateral position from the beginning as shown in the virtual line.

The cutting section 121 is provided in close vicinity to the return roller 132 in the middle of a substantially horizontal conveyance pass from the return roller 132 to the outlet 128 and is provided with a cutter blade 137 for cutting the gap of the printed continuous tape 108. The cutter blade 137 has a known mechanical structure whereby the blade moves vertically.

The timing for cutting by the cutter blade 137 is controlled by a cut timing sensor 138. The cut timing sensor 138 consists of transmitted light sensors which are disposed on each side of the conveyance pass and are shut off from light when the leading end of the printed continuous tape 108 passed the cutter blade 137 reaches there. Accordingly, the cut timing sensor 138 detects the leading end and then detects the sensor mark 113 of the printed continuous tape 108 whenever it passes the cut timing sensor 138. In this manner, if the cutter blade 137 is interlocked whenever the leading end or the sensor mark 113 is detected, it is possible to cut the labels one by one.

Further, if a position of the cut timing sensor 138 is adjusted so that the distance between the cut timing sensor 38 and the cutter blade 137 becomes precisely the cut width of the label, it is possible to cut the printed continuous tape 108 simply and correctly. However, if the structure to control the cutter blade 137 is provided by inputting the cut width information of the label in advance without making the positional adjustment of the cut timing sensor 138, the printed continuous tape 108 can be controlled to be correctly cut by the detection signal of the cut timing sensor 138, the cut width information, and the feed speed.

By providing the cut timing sensors 138 on the front side of the cutter blade 137 in the feeding direction, the cutter blade 137 can be controlled after detecting passage of the sensor mark 113. Accordingly, it is possible to correctly cut the printed continuous tape 108 even though the tape 108 is mixedly provided with long and short cut width

The conveyor section 122 is a section for feeding a separate label 112 cut by the cutter blade 137 to the activating section 123, wherein the label 112 is inserted between the upper and lower conveyor belts 140, 141 to prevent displacement such as slant movement.

The upper and lower conveyor belt 140, 141 have flat belts engaged with rollers 142, 143, respectively.

The activating section 123 is provided with a heating timing sensor 144, a pressure contact roller 145, and a heater 147. The heating timing sensor 144 is the same type of transmitted light sensor as the cut timing sensor 138 and detects passage of the label. The roller 143 of the conveyor section 122 and the pressure contact roller 145 are driven together by an outlet motor 139.

The pressure contact roller 145 rotates the label 112 fed between the pressure contact roller 145 and the heater 147 pressing the label to the heater 147, thereby feeding it to the plasticizer coating section 124. In this case, since the label is fed with the adhesive agent layer 115 face downwards, the adhesive agent layer 115 is pressed to the heater 147 to heat the section contacting with the heater 147, thereby activating the adhesive agent layer 115. The heater 147 is an electric heater of which the contact section with the adhesive agent layer 115 is flat and it can efficiently heat a large area in a short time. The surface temperature of the heater 147 is set to have a temperature sufficient to activate the adhesive agent layer 115.

The plasticizer coating section 124 is constructed in such a manner that a sponge roller 152 half-immersed in a tank 151, which is similar to the tray 21 in the first embodiment, in which a plasticizer 150 is contained contacts the label from the lower surface. By coating the plasticizer 150 on the activated adhesive agent layer 115, crystallization of the adhesive agent layer 115 is prevented to maintain the adhesive force for a long time. Particularly, in the case where the surface to be adhered to is very rough as seen in an air cushion sheet, it is possible to effectively prevent crystallization from advancing from the exposed section and prevent the adhesive force of the adhesive agent layer 115 from decreasing due to aged deterioration. The plasticizer 150 can be a known substance such as terpene resin similar to the first embodiment. The label 112 coated with the plasticizer 150 is inserted between the sponge roller 152 and a discharge pinch roller 153 to be fed to the ejection section 125.

The discharge pinch roller 153 is vertically moved by a roller operating section 146 composed of a solenoid, a motor and the like. When the movement of the label is stopped, the discharge pinch roller 153 is lifted upward by the roller operating section 146 to separate the discharge pinch roller 153 from the label, thereby preventing the plasticizer from being coated excessively. It should be noted that the sponge roller 152 can be moved vertically.

The ejection section 125 is a section for ejecting the label 112 received from the sponge roller 152 of the plasticizer coating section 124 through the outlet 128 and is provided with an ejection belt 154, rollers 155, 156 for moving the belt 154, and an ejection sensor 157. The roller 156 situated at the top of the ejection belt 154 projects from the discharging outlet 128 in the direction to which the label 112 is ejected, wherein the top end of the roller 156 slopes down.

The ejection belt 154 is provided by aligning several belts of which the cross-section is round in parallel at certain intervals and is in line contact with the activated adhesive agent layer 115 so that the contact area is as small as possible. The ejection sensor 157 is a reflection sensor. The ejection sensor 157 stops the outlet motor 139 when the label 112 is situated above the ejection sensor 157 and actuates the roller operating section 146, thereby moving the pressure contact roller 145 upward.

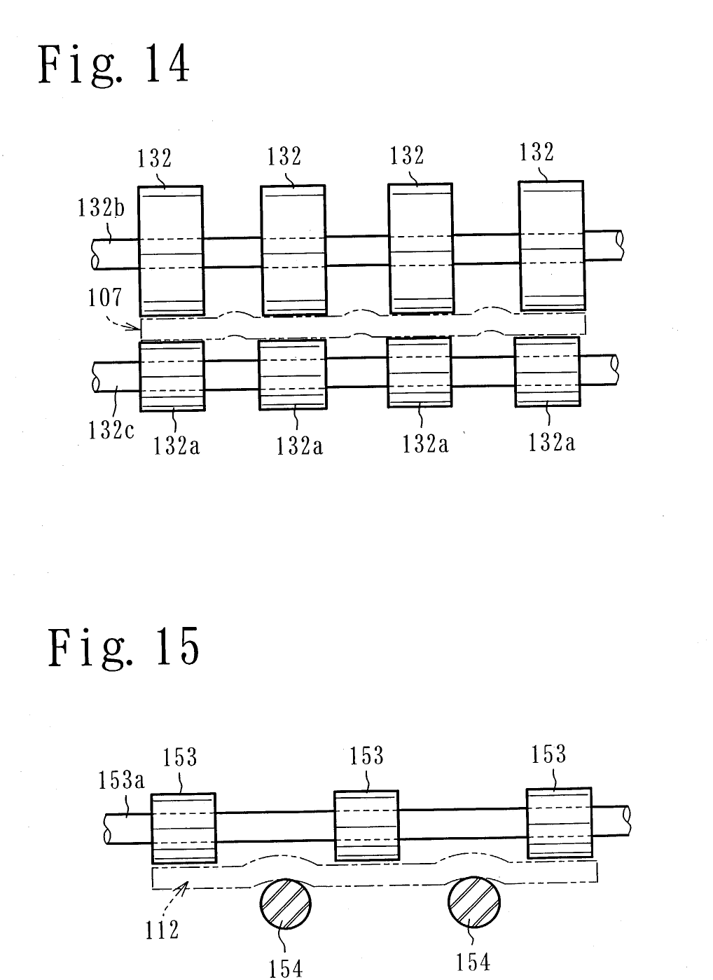

FIG. 14 is a view showing the return roller 132 from the direction of the arrow B of FIG. 13, wherein a plurality of return rollers 132 is provided around a rotation axis 132b at certain intervals in the axial direction. An idle roller 132a also has the same construction as the return roller 132. In this manner, since a long inflection shape is given to the printed continuous tape 108 in the feed direction to form a kind of rib shape, it is possible to improve the strength of the printed continuous tape 108.

FIG. 15 is a view showing the relationship between the discharge pinch roller 153 and the ejection belt 154 from the direction of the arrow C of FIG. 13. Discharge pinch rollers 153 are provided around a rotation axis 153a in the same manner as the idle roller 132a at certain intervals to improve the strength of the label 112. The ejection belt 154 is provided, situated between the adjacent discharge pinch rollers 153, 153, and adhesion of the adhesion agent layer 115 relative to the ejection belt 154 is arranged to be as weak as possible.

Operation of the present embodiment will now be explained. According to the affixing method of the present embodiment, the required number of labels is continuously printed on the unprinted continuous tape 107 forming a label with no releasable paper and then, the unprited continuous tape 107 is separated into predetermined lengths by the printer 105. In this manner, a printed continuous tape 108 is formed. In this case, an adhesive layer remains an inactive adhesive agent layer 115 and no releasable pare is required.

Then, the printed continuous tape 108 is formed in a roll shape to make it compact for easy handling. A worker takes this compact roll-shaped label tape 8 to one of the affixing sites which are dispersedly located around the printer 5 and install it in the separating means 10.

The separating means 110 cuts the printed continuous tape 108 using the cutter blade 137 for each label 112, activates the inactive adhesive agent layer 115 of each label 112 using the heater 147, and feeds it to the ejection section 125. After removed from the ejection section 125, the labels 112 are affixed to a package and the like, one by one. This can be efficiently performed simultaneously in a plurality of affixing sites.

In this case, the existence of the sensor mark 113 and the cut timing sensor 138 in the separating means 110 is extremely important. Even though the printed continuous tape 108 of free length is formed by the printer 105, the printed continuous tape 108 is correctly cut and activated for each label by the separating means 110. Accordingly, in addition to adoption of the label without releasable paper, these are factors to make the present system, which makes the affixing operation possible in the condition close to the site, substantially possible when the separating means 110 is disposed at a location far from the printer 105.

In this manner, since only one expensive printer 105 is installed, it is possible to raise the efficiency of use of the printer 105 and to reduce the entire cost. Since the releasable paper is not generated, the burden on the environment can be lessened. Further, since the separating means 110 is arranged in close vicinity to the affixing sites, it is possible to make the affixing operation easy. Still further, since the order of process of printing, cutting, and activation is adopted, it is possible to realize the most rational and economic structure.

According to the apparatus of the present embodiment, since the separating means 110 is provided with the feed section 120, the cutting section 121, the conveyor section 122, the activating section 123, and the ejection section 125, each function of separation and activation can be sufficiently and efficiently attained. Since the plasticizer coating section 124 is also provided therein, the coated plasticizer 150 prevents a decrease in performance due to crystallization of the activated adhesive agent to make stable use for a long time possible.

In the feed section 120, the printed continuous tape 108 of a roll shape can be supported by the arm 130 and the labels 112 can be fed one by one. In this case, if the arm 130 is swingably provided, the feed direction can be selectively changed according to the material (including the hardness due to thickness) of the printed continuous label tape 108 and the like. Further, if the depressed section 129a of the feed section 120 is deepened and made sufficiently large, the folded, printed continuous tape 108 can be stored there and fed to the inside of the apparatus.

The detecting means consisting of the inlet sensor 136, the cut timing sensor 138, the heating timing sensor 144 and the ejection sensor 157 is provided. Accordingly, the top of the label or the sensor mark 113 is detected relative to the printed continuous tape 108 or the individually fed labels 112 and is fed to the cutting section 121 at a fixed pitch. Thus, correct feeding can be realized.

With this feeding mechanism, it is possible to cut the label using the cutter 137 individually or continuously. Since both the cut timing sensor 138 and the heating timing sensor 144 are transmitted light sensors, it is possible to make the sensor type used in the printer 105 common. Accordingly, it is not necessary to make the sensor system of the separating means 110 specific. Thus, it is possible to keep the structural cost of the separating means 110 low.

Further, the conveyor section 122 can utilize any of a belt, a roller, absorption, holding or adhesion. The plasticizer coating section 124 is provided with the sponge roller 152 for transferring the plasticizer 150 and the discharge pinch roller 153 to be pressed against the surface of the sponge roller 152. The discharge pinch roller 143 is vertically moved by the roller operating section 146, which consists of a solenoid or a motor. Accordingly, when the movement of the label 12 is stopped, it is possible to prevent an excess of the plasticizer 150 from adhering to the adhesive agent layer 115 by releasing the pressure contact.

The ejection section 125 is provided with an ejection mechanism by the ejection belt 154 of which the cross-section is round. Accordingly, it is possible to reduce the quantity of the adhesive agent or the plasticizer adhering to the ejection belt 154 of the ejection section 125 and thus, workability improves. Since the head of the ejection belt 154 projects from the ejection outlet 128, the label 112 can be easily grasped.

The ejection section 125 is also provided with the ejection sensor 157 which detects the label 112 as far as it remains left at the ejection section 125 and stops the movement of the label in the separating means 110. In this manner, the affixing operation can be carried out at the best timing for the worker.

Application of each section will now be shown. Though the feeding section 120 was explained about cases in which a roll shape and a cut shape paper are used, continuously folded paper such as computer paper can be fed. In this case, the inlet 127 can be provided with a tray for housing the folded type printed continuous tape 108 therein. This is convenient in the case where the printer 105 has a structure for printing and outputting in the folded shape. The return roller 132 and the idle roller 132a can be made of metal or plastic, and also can be a gear drive type.

The cutting section 121 can be provided with various systems in place of a mechanical type of cutter blade 137. The mechanical type also includes a rotary type. It is also possible to make use of a laser beam, ultrasonic waves, hot wire and the like. There is a type or method whereby the tape can be torn along perforations or the wet separating section can be cut by a cutter or torn away.

The inlet sensor 136 is not the transmitted light type, but various types are available. For example, known methods or types such as a read type for reading the printed sensor mark, a reflection type for detecting reflected light by providing a reflecting section, and a magnetic detection type by a magnetic substance mark can be adopted.

Even one label can be detected by increasing the number of sensors or by changing the detecting method in order to detect up to the rear end of the head. In the type whereby only the head is detected to output the cut signal, though there is some possibility that even the last label is not cut, this problem can be solved.

In the conveyor section 122, the conveyance form can be a belt, a roller, absorption, holding, adhesion and the like. In the case of a belt, a timing belt, a V-belt, a round belt and the like can be selectively used. Material for the belt can be arbitrarily selected from metal, plastic, rubber and the like.

In the roller type, a plurality of rotation rollers is aligned. A drive type roller in which each roller or part thereof is driven can be used. If the entire section is inclined, the label can move by its own weight.

The absorption method is a method whereby the label is absorbed to the surface of a conveyance member such as a roller by pressure reduction, a suction cup or the like. The holding method conveys the label by holding it by a holding mechanism in place of the absorption. The adhesion method conveys the label by temporarily causing it to adhere by making use of the adhesive force of the adhesive agent in place of the absorption.

As these conveyance means, there are various means such as a roller, a belt conveyor, an air cylinder or a hydraulic cylinder, and a robot arm.

A method for coating the plasticizer 150 in the plasticizer coating section 124 includes blowing and brushing. In the roll transfer printing, the roller operating section 146 can be a motor drive.

The ejection section 125 can utilize a conveyance method such as the holding method and the absorption method described above in place of the ejection belt 154.

The adhesive agent layer 115 is not limited to a thermosensitive layer. For example, activation can be performed using an adhesive agent having water solubility, pressure reactivity, ultraviolet reactivity, and the like.

In the case of water solubility, water can be applied or coated by blowing, brushing, roll transfer, and the like.

The pressure reactive method is a method whereby a pressure-sensitive adhesive agent such as an adhesive agent contained in a micro capsule is used, wherein pressure can be applied by a roller pressure contact, face press, and the like.

The ultraviolet reactive method is a method for activating by irradiating ultraviolet by a known ultraviolet lamp, wherein an apparatus available in the market can be readily used.

The present invention is effective even in the case where there is but one affixing site, and one each of the printer 105 and the separating means 110. Namely, when the affixing site is far from the printing site, it is not necessary to install the printer 105 in the affixing site. In this manner, additional equipment is not required and the affixing operation can be carried out on site.

At the stage of the unprinted continuous tape 107 and the printed continuous tape 108, a method whereby the adhesive agent layer is not provided is also possible. In this case, the printer 105 prints predetermined information on the unprinted continuous tape which is not provided with the adhesive agent layer, thereby forming the printed continuous tape (which is not provided with the adhesive agent layer in this stage). Subsequently, the printed continuous tape is carried to an individual working area 103 and installed in the separating means 110. The separating means 110 adopts the adhesive agent coating section in place of the activating section 123, wherein the continuous tape is coated with adhesive agent and removed via the ejection section 125. Wherein, the continuous tape is the label tape of the present application from a stage of the unprinted continuous tape 107 without the adhesive agent layer.

With this arrangement, a special adhesive agent layer 115 is not required and there is no adhesive agent layer between the printer 105 and installation of the printed continuous tape in the separating means 110. Accordingly, handling is easy and this is not affected by a change of environmental temperature. In addition, the label having no releasable paper in which a special adhesive agent is used is not required and the activation means is not required. Accordingly, it is possible to simply realize label affixing without releasable paper.

In this manner, it is possible to form the adhesive agent layer just before affixing in the vicinity of the separating means 110 which is provided at the affixing site. Further, the adhesive agent layer can be easily formed by any of blowing, roll transfer or brushing. Still further, the plasticizer coating section can be omitted. In addition, if an adhesive agent container or cartridge is prepared, it is possible to prevent the adhesive agent from drying.

The order of process consisting of printing, cutting and activation can also be freely combined. In the case where the continuous tape is used, there are the following methods:

\mathring{1} Printing→Cutting→Activation (Order of the above mentioned embodiment);

\mathring{2} Printing→Activation→Cutting

\mathring{3} Cutting→Printing→Activation

\mathring{4} Cutting→Activation→Printing

\mathring{5} Activation→Printing→Cutting

\mathring{6} Activation→Cutting→Printing

\mathring{2} is suitable in the case where the length is unspecified. \mathring{3} and \mathring{4} are suitable for a thick object which has to be cut in advance. \mathring{4} through \mathring{6} are possible in the case where ink jet printing is used.

An individual label can be used from the beginning in place of the continuous tape. In this case, the following combination can be considered:

\mathring{7} Printing→Activation

\mathring{8} Activation→Printing

What is claimed is:

1. A label having a front surface printed with a required information as a label and a reverse surface coated with an adhesive agent which does not adhere at room temperature, but recovers adherence when heated, characterized in that a plasticizing material is coated on the adhesive agent which recovers adherence on heating.

2. The label according to claim 1, wherein the label is formed in a long belt-shape and is continuously printed with a plurality of required information thereon.

3. A method for using a label characterized in that a label having a reverse surface coated with an adhesive agent which does not adhere at room temperature, but recovers adherence when heated is heated to generate an adhesive force, then a plasticizing material is coated on the adhesive agent, thereby affixing the label to an adherend.

4. A method for using a label in which a label tape formed in a long belt-shape is continuously printed with a plurality of required information on a surface and has a reverse surface coated with an adhesive agent which does not adhere at room temperature, but recovers adherence when heated, the method comprising the steps of:
forming a tape roll by rolling the long belt-shape label tape in a roll;
unrolling the label tape from the tape roll;
cutting the printed label tape for each label;
heating the adhesive agent on the reverse surface of the cut label using a heater;
coating a plasticizing material on the adhesive agent which recovers adherence by heating; and
affixing the label to an adherend by the adhesive agent coated with the plasticizing material.

5. A method for using a label in which a label tape formed in a long belt-shape has a reverse surface coated with an adhesive agent which does not adhere at room temperature, but recovers adherence when heated, the method comprising the steps of:
forming a tape roll by rolling the long belt-shape label tape in a roll;
unrolling the label tape from the tape roll;
continuously printing required information on the surface of the unrolled label tape;
cutting the printed label tape for each label;
heating the adhesive agent on the reverse surface of the cut label using a heater;
coating a plasticizing material on the adhesive agent which recovers adherence; and
affixing the label to an adherend by the adhesive agent coated with the plasticizing material.

6. A method for affixing a label with no releasable paper having one surface provided with an adhesive agent layer to which an adhesive force is applied through a predetermined activation treatment and having the other surface printed with predetermined information required as the label, comprising the steps of:
continuously printing a plurality of the required information on a long label tape and cutting the continuous label tape in predetermined lengths using one printer, thereby feeding the tape to one or more label affixing sites; and
separating the cut label tape for each label in the label affixing site using a separating means and activating the adhesive agent layer, thereby performing the label affixing operation.

7. A method for affixing a label with no releasable paper having one surface provided with an adhesive agent layer and having the other surface printed with predetermined information required as the label, comprising the steps of:
continuously printing a plurality of labels on a long label tape which is not provided with an adhesive agent layer and separating the label tape into predetermined lengths using one printer, thereby feeding the label tape to one or more label affixing sites; and
separating the label tape for each label in the label affixing site using a separating means and forming the adhesive agent layer thereon, thereby performing the label affixing operation.

8. An apparatus for affixing a label with no releasable paper having one surface provided with an adhesive agent layer to which an adhesive force is applied through a predetermined activation treatment and having the other surface printed with predetermined information required as the label comprising:
a printer for printing a plurality of labels on a long label tape and separating the label tape into predetermined lengths; and
a separating means for separating the printed label tape for each label and activating the adhesive agent layer;
wherein one or more separating means are dispersedly provided for one printer, the label tape printed out by the printer in the predetermined lengths is carried to each separating means, and the separating means separates and activates the label tape for each label, thereby performing the label affixing operation.

9. An apparatus for affixing a label with no releasable paper having one surface provided with an adhesive agent layer and having the other surface printed with predetermined information required as the label, comprising:
a printer for continuously printing a plurality of labels on a long label tape which is not provided with an adhesive agent layer and separating the label tape into predetermined lengths; and
a separating means for separating the printed label tape for each label and forming the adhesive agent layer;
wherein one or more separating means are dispersedly provided for one printer, the label tape printed out by the printer into the predetermined lengths is carried to the separating means; and
wherein the label tape is separated for each label by the separating means, the adhesive agent layer is formed thereon, and then, the label affixing operation is performed.

10. The apparatus for affixing a label according to claim 8, wherein the separating means is provided with a label feeding section, a cutting section, a conveyor section, an activating section, and an ejection section.

11. The apparatus for affixing a label according to claim 10, wherein the separating means is provided with a plasticzier coating section for coating a plasticizer on the activated adhesive agent layer by blowing, roll transfer or brushing.

12. The apparatus for affixing a label according to claim 11, wherein the plasticizer coating section of the separating means is provided with a transfer roller for roll transfering the plasticizer and a pressure roller for applying pressure on the surface of the transfer roller, wherein the pressure roller is vertically moved by a solenoid or a motor.

13. The apparatus for affixing a label according to claim 11, wherein an ejection section of the separating means is provided with an ejection mechanism by a belt of which the cross-section is round.

14. The apparatus for affixing a label according to claim 9, wherein the separating means is provided with a label feeding section, a cutting section, a conveyor section, an adhesive agent forming section, and an ejection section.

15. The apparatus for affixing a label according to claim 10 or claim 14, wherein the feeding section of the separating means is provided with a supporting member for supporting the printed label tape formed in a roll shape and a structure which can feed the label individually.

16. The apparatus for affixing a label according to claim 15, wherein the bar swings.

17. The apparatus for affixing a label according to claim 10 or claim 14, wherein the feeding section of the separating means is provided with a mechanism for feeding the folded label tape and a structure which can also feed the label individually.

18. The apparatus for affixing a label according to claim 10 or claim 14, wherein the separating means is provided with a detecting means for detecting part of the label and for feeding the label to the cutting section at a fixed pitch relative to the label tape or the label fed individually.

19. The apparatus for affixing a label according to claim 10 or claim 14, wherein the separating means is provided with a cutting section having a cutter for cutting the label, individually or continuously, fed from the feeding section.

20. The apparatus for affixing a label according to claim 10 or claim 14, wherein the conveyor section of the separating means conveys the label by means of a belt or roller, absorption, holding or adhesion.

21. The apparatus for affixing a label according to claim 10, wherein the activating section of the separating means activates the adhesive agent layer of the label by any of water, infrared rays, ultraviolet rays, a laser beam, an incandescent light, pressure, microwaves or heat.

22. The apparatus for affixing a label according to claim 14, wherein the adhesive agent layer forming section of the separating means forms the adhesive agent layer on the label conveyed from the conveyor section by any of blowing, roll transfer or brushing and is provided with an adhesive agent container or cartridge for preventing the adhesive agent from drying.
